(19) United States
(12) Patent Application Publication
(10) Pub. No.: US 2008/0164674 A1
(43) Pub. Date: Jul. 10, 2008

(54) Front fork with photoelectric module

(76) Inventor: Hui-Hsiung Chen, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,719

(22) Filed: Mar. 14, 2007

(30) Foreign Application Priority Data
Jan. 8, 2007 (TW) 096200318

(51) Int. Cl. B62K 21/02

(52) U.S. Cl. 280/280

(57) ABSTRACT

A front fork includes two first leg units between which a crown is connected. One of the two leg units includes a sleeve fixedly inserted in the inner tube and a battery case is received in the sleeve. The battery case is connected with a positioning member which is fixed to a lower end of the sleeve with a spring set biased between the lower end of the battery case and the positioning member. A photoelectric module is connected to a top end of the battery case and powered by the batteries in the battery case. The photoelectric module is activated to light up or generates light beam during nights.

### FIELD OF THE INVENTION

The present invention relates to a bicycle front fork which a photoelectric module connected thereto so that the rider can be seen in dark area.

### BACKGROUND OF THE INVENTION

A conventional bicycle front fork is shown in FIG. 8, and generally includes two leg units 70 (only one is shown) and a crown 60 is connected between the two leg units 70. Each leg unit 70 has an inner tube 71 and an outer tube 72 with a rubber bush 73 connected therebetween, the inner tube 71 is retractably inserted into the outer tube 72. A pumping device is received in the inner tube 71 and provides proper resistance so as to absorb shocks from serrated the ground. The conventional front fork provides nothing more than buffering the shocks.

The present invention intends to provide a front fork that has a photoelectric module connected to a top of one of the leg units and the photoelectric module provides different patterns of warning signals during night. Besides, the front fork also provides a storage space for storing maintenance tools therein.

### SUMMARY OF THE INVENTION

The present invention relates to a front fork which comprises a first leg unit and a second leg unit, a crown is connected between the first and second leg units, and a steerer tube is connected to the crown. Each of the first and second leg units has an inner tube and an outer tube. The inner tube has an end movably inserted into the outer tube and the other end of the inner tube is connected to the crown. A space is defined in the inner tube and communicates with an opening on a top end of the inner tube. A sleeve is fixedly inserted in the inner tube and has a space defined therein. A battery case is received in the space of the sleeve and a photoelectric module is connected to a top end of the battery case. Two protrusions extend radially from a lower end of the battery case and are connected with a positioning member which is fixed to a lower end of the sleeve. A spring set is biased between the lower end of the battery case and the positioning member.

The primary object of the present invention is to provide a front fork for a bicycle and a photoelectric module is connected to the front fork, the photoelectric module generates light beams which make the rider more visible in nights.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the front fork with the photoelectric module of the present invention connected thereto;

FIG. 2 is a cross sectional view to show the front fork with the photoelectric module of the present invention connected thereto;

FIG. 3 is an exploded view to show the sleeve, the battery case and the photoelectric module of the present invention;

FIG. 4A shows the photoelectric module of the present invention is located at a top of the sleeve;

FIG. 4B is a cross sectional view to show the photoelectric module of the present invention is connected to a top of the battery case;

FIG. 5 shows another embodiment of the front fork of the present invention;

FIG. 6 shows a pumping device is received in the sleeve of the front fork of the present invention;

FIG. 7 shows the photoelectric module of the present invention connected to the front fork generates a light beam, and

FIG. 8 shows a conventional front fork.

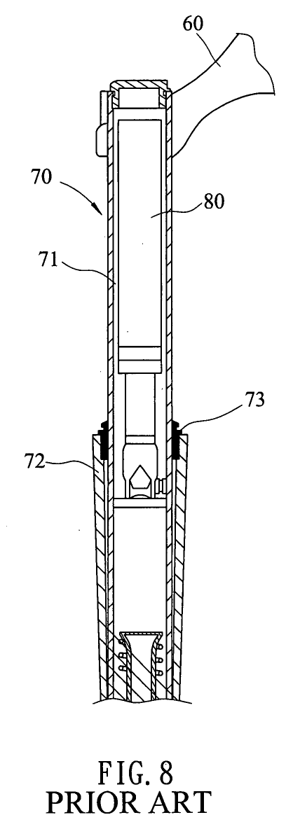

### DETAILED DESCRIPTION OF THE PREFERRED EMBODIMENT

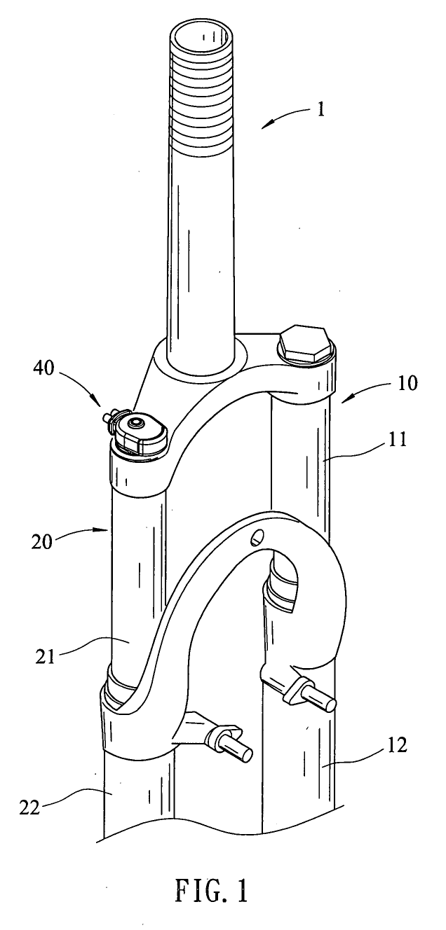

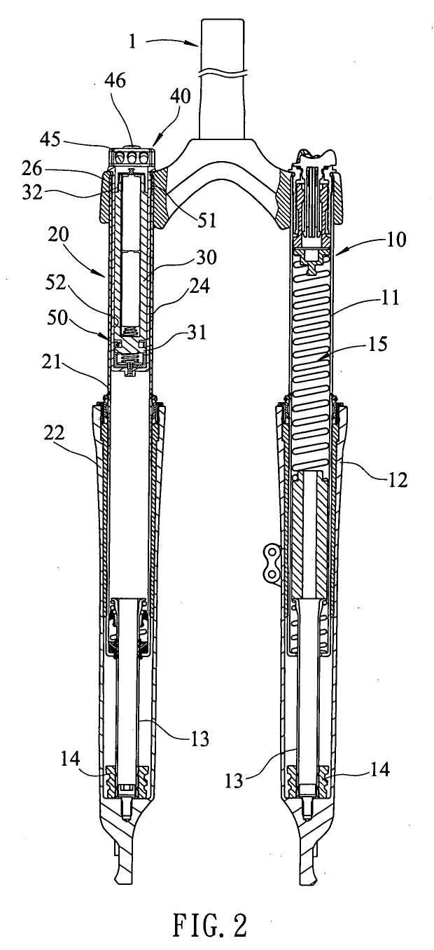

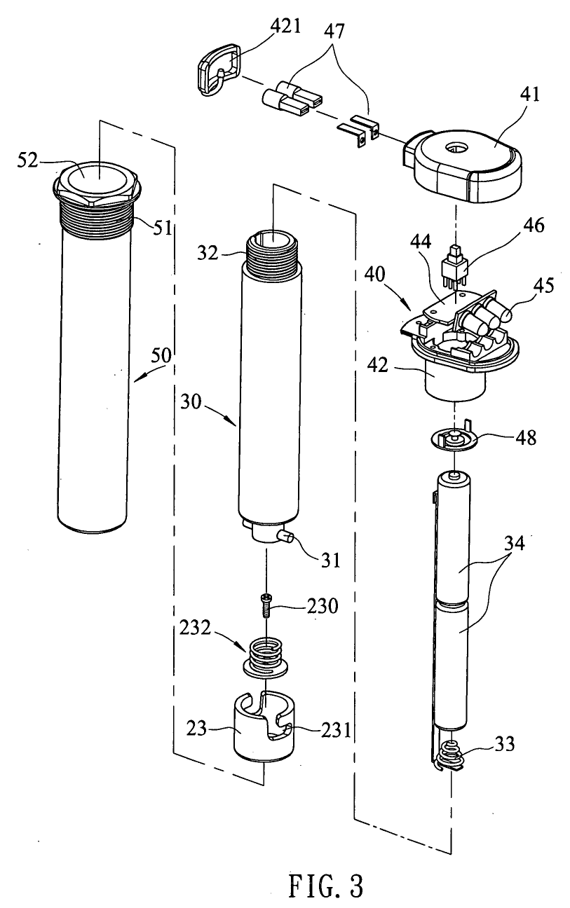

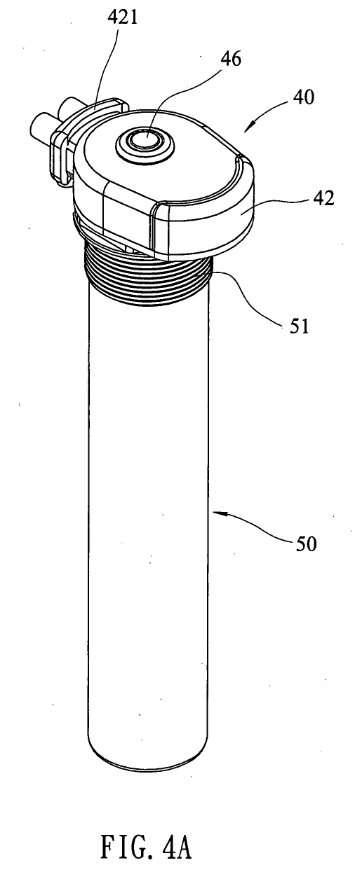

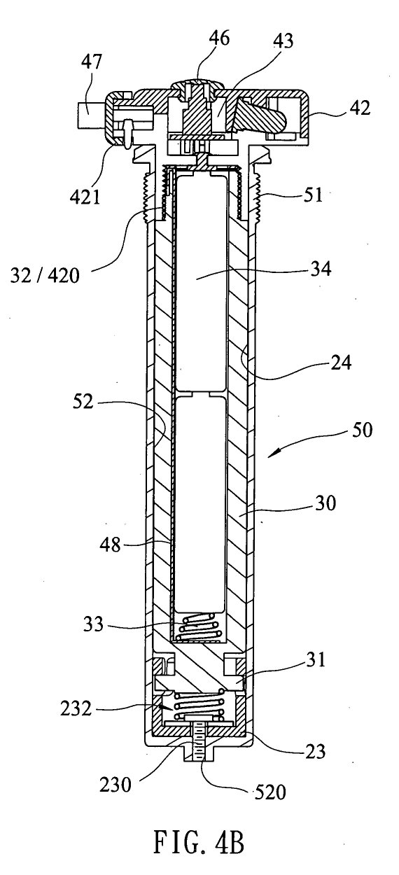

Referring to FIGS. 1, 2, 3, 4A and 4B, the front fork 1 of the present invention comprises a first leg unit 10 and a second leg unit 20. A crown is connected between the first and second leg units 10, 20, and a steerer tube is connected to the crown. The first leg unit 10 has a first inner tube 11 and a first outer tube 12, the first inner tube 11 has an end movably inserted into the first outer tube 12 and the other end of the first inner tube 11 is connected to the crown. A rod 13 is connected to an inner end of the first outer tube 12, a buffering member 14 is mounted to the rod 13 and rested on the inner end of each of the first outer tubes 12. A spring 15 is received in the first inner tube 11 and biased between an end member seals the top of the first inner tube 11 and a tube located on the rod 13.

The second leg unit 20 has a second inner tube 21 and a second outer tube 22. The second inner tube 21 has an end movably inserted into the second outer tube 22 and the other end of the second inner tube 21 is connected to the crown. A space 24 is defined in the second inner tube 21 and communicates with an opening 25 on a top end of the second inner tube 21. A rod 13 is connected to an inner end of the second outer tube 22, a buffering member 14 is mounted to the rod 13 and rested on the inner end of the second outer tubes 12.

A sleeve 50 is fixedly inserted in the second inner tube 21 and has a space 52 defined therein. The second inner tube 21 includes inner threads 26 and the sleeve 50 includes outer threads 51 with which the inner threads 26 are engaged. A battery case 30 is received in the space 52 of the sleeve 50 and a photoelectric module 40 is connected to a top end of the battery case 30. Two protrusions 31 extend radially from a lower end of the battery case 30 and connected with a positioning member 23 which is fixed to a lower end of the sleeve 50. A spring set 232 is biased between the lower end of the battery case 30 and the positioning member 23. The positioning member 23 includes a tubular wall which defines an open top and two L-shaped slots 231 are defined in the tubular wall, the two protrusions 31 on the battery case 30 are engaged with the L-shaped slots 231. A bolt 230 extends through the positioning member 23 and is threadedly connected with a positioning holes 520 defined through the lower end of the sleeve 50. The photoelectric module 40 includes a base 43 and a transparent cap 41 is mounted to the base 43. The transparent cap 41 can be made with a desired color and provides water proof feature. A circuit board 44 is received in the base 43 and the circuit board 44 can be powered by the batteries 34 received in the battery case 30 or be charged by a charging device which is not shown. A spring 33 is located between the batteries 34 and the inner end of the battery case 30 so as to push the batteries 34 toward the photoelectric module 40. A lighting module 45 is connected to the circuit board 44 and a switch 46 on the cap 41 is connected to the lighting module 45. The switch 46 is connected with a connection unit 47 and electrode disk 48. A end cover 421 is connected to a side of the cap 41 so as to prevent water from entering the inner space of the cap 41 so as to protect the connection unit 47 and electrode disk 48. A connection end 42 extends from the base 43 and has a threaded inner periphery 420, the battery case 30 has outer threads 32 defined in the top end thereof so as to be connected with the threaded inner periphery 420 of the connection end 42.

The battery case 30 together with the photoelectric module 40 be removed from the sleeve 50 by disengaging the protrusions 31 out from the L-shaped slots 231 of the positioning member 23, and the photoelectric module 40 can be used as a flashlight.

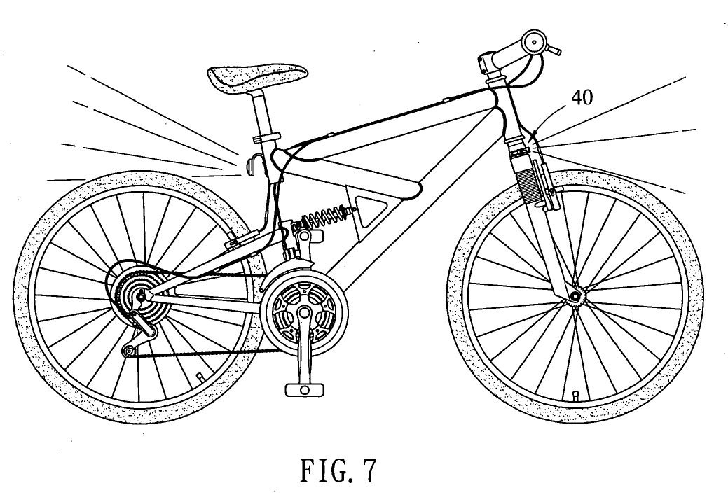

Further referring to FIG. 7, when the user pushes a switch 46 on a top of the cap 41 of the photoelectric module 40, the photoelectric module 40 generates light beams which make the rider more visible at nights.

The photoelectric module 40 can also be an induction device which can be activated by mercury or vibration. The photoelectric module 40 performs as an anti-theft warning device which may produces sound when the bicycle is moved without permission.

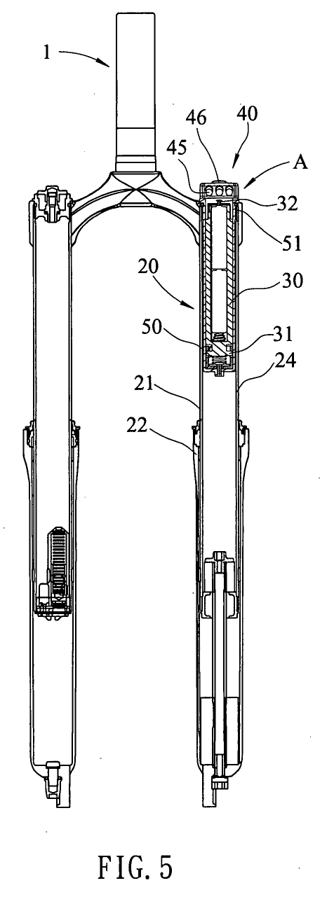

FIG. 5 shows that the photoelectric module 40 is connected with the second leg unit 20 and the first leg unit 10 is equipped with a hydraulic suspension device.

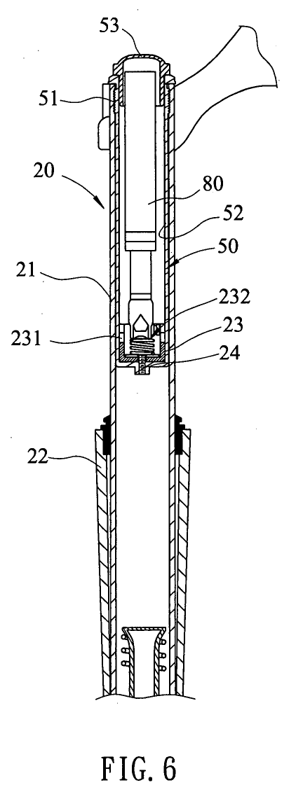

FIG. 6 shows that the sleeve 50 can also be used as a storage device wherein the battery case 30 is removed and the photoelectric module 40 is replaced with a cover 53. The space 52 in the sleeve 50 can be used for storage of a pumping device 80 or maintenance tools.

While we have shown and described the embodiment in accordance with the present invention, it should be clear to those skilled in the art that further embodiments may be made without departing from the scope of the present invention.

What is claimed is:

1. A front fork comprising:
a first leg unit and a second leg unit, a crown connected between the first and second leg units, a steerer tube connected to the crown, the first leg unit having a first inner tube and a first outer tube, the first inner tube having an end movably inserted into the first outer tube and the other end of the first inner tube connected to the crown;
the second leg unit having a second inner tube and a second outer tube, the second inner tube having an end movably inserted into the second outer tube and the other end of the second inner tube connected to the crown, a space defined in the second inner tube and communicating with an opening on a top end of the second inner tube, and
a sleeve fixedly inserted in the second inner tube and having a space defined therein, a battery case received in the space of the sleeve and a photoelectric module connected to a top end of the battery case.

2. The front fork as claimed in claim 1, wherein two protrusions extend radially from a lower end of the battery case and are connected with a positioning member which is fixed to a lower end of the sleeve, a spring set is biased between the lower end of the battery case and the positioning member.

3. The front fork as claimed in claim 2, wherein a bolt extends through the positioning member and is threadedly connected with a positioning holes defined through the lower end of the sleeve.

4. The front fork as claimed in claim 3, wherein the positioning member includes a tubular wall which defines an open top and two L-shaped slots are defined in the tubular wall, the two protrusions on the battery case are engaged with the L-shaped slots.

5. The front fork as claimed in claim 1, wherein batteries are received into the battery case and electrically connected with the photoelectric module, the photoelectric module includes a base and a transparent cap mounted to the base, a circuit board received in the base.

6. The front fork as claimed in claim 1, wherein the second inner tube includes inner threads and the sleeve includes outer threads with which the inner threads are engaged.

7. The front fork as claimed in claim 1, wherein a rod is connected to an inner end of each of the first and second outer tubes, a buffering member is mounted to the rod and rested on the inner end of each of the first and second outer tubes.

8. The front fork as claimed in claim 1, wherein a connection end extends from the base and has a threaded inner periphery, the battery case has outer threads defined in the top end thereof so as to be connected with the threaded inner periphery of the connection end.

9. The front fork as claimed in claim 1, wherein the photoelectric module is an induction device which is activated by mercury.

10. The front fork as claimed in claim 1, wherein the photoelectric module is an induction device and produces sound.
